(19) United States
(12) Patent Application Publication
(10) Pub. No.: US 2017/0220197 A1
(43) Pub. Date: Aug. 3, 2017

(54) INPUT DEVICE, SYSTEM, METHOD OF MANUFACTURING INPUT DEVICE AND DISPLAY DEVICE

(71) Applicant: FUJITSU TEN LIMITED, Kobe-shi (JP)

(72) Inventors: Shinsuke MATSUMOTO, Kobe-shi (JP); Hironori SHIROTO, Kobe-shi (JP)

(21) Appl. No.: 15/408,809

(22) Filed: Jan. 18, 2017

(30) Foreign Application Priority Data
Feb. 2, 2016 (JP) 2016-018347
Jul. 12, 2016 (JP) 2016-137631

(51) Int. Cl. G06F 3/041; G06F 3/01

(52) U.S. Cl. CPC G06F 3/0418; G06F 3/016; G06F 2203/04103

(57) ABSTRACT

There is provided an input device configured to receive a user's touch operation and to output a control signal. A first plate is configured to receive the user's touch operation. A vibrator configured to vibrate the first plate. A second plate is fixed with a predetermined interval between the first plate and the second plate and configured to support the first plate.

### CROSS-REFERENCE TO RELATED APPLICATIONS

This application is based on and claims priority from Japanese Patent Application No. 2016-018347 filed on Feb. 2, 2016 and Japanese Patent Application No. 2016-137631 filed on Jul. 12, 2016.

### TECHNICAL FIELD

The disclosure relates to an input device, a system, a method of manufacturing an input device and a display device.

### BACKGROUND

An input device with which a user touches an operation surface (touch operation) to perform an input, such as a display or a touch pad having a touch panel has been known. It is possible to provide a tactile sense to a user who is touching the operation surface by vibrating the operation surface of the input device (for example, refer to Patent Document 1 and Patent Document 2).

Patent Document 1: International Patent Publication No. WO 2012/160827

Patent Document 2: Japanese Patent Application Publication No. 2012-203895A

When vibrating the operation surface, as described above, if a plate thickness of the operation surface is thick, a noise resulting from the vibration increases. On the other hand, when the plate thickness of the operation surface is made to be thin so as to suppress the noise, it is not possible to secure mechanical strength with respect to the touch operation, so that the operation surface is likely to be damaged.

An input device has been known which is configured to receive a user's input operation by detecting a user's touch operation on an operation surface of an operation unit and to provide the user with a tactile sense by vibrating the operation unit.

For example, in a touch screen device, a rigid member mounted to an image display unit, which is mounted to a touch screen panel, and configured to vibrate includes a unit configured to generate vibration, a mass body for increasing mass and an elastic member for increasing vibration displacement (for example, refer to Patent Document 3).

Patent Document 3: Japanese Patent Application Publication No. 2011-060261A

However, in the input device, when vibrating the operation unit, the noise may be generated depending on a thickness and a material property of a vibration plate configuring the operation unit, for example.

Herein, in the input device, it is considered to reduce the thickness of the vibration plate configuring the operation unit so as to reduce the noise that is to be generated when vibrating the operation unit.

However, in the input device, when the thickness of the vibration plate configuring the operation unit is reduced, the vibration of the operation unit may be unstable. As a result, it may not be possible to appropriately provide the tactile sense to the user who is performing the touch operation on the operation surface of the operation unit.

### SUMMARY

A first object of the disclosure is to suppress damage of an operation surface even when a plate thickness of the operation surface is made to be thin so as to suppress a noise.

A second object of the disclosure is to reduce the noise that is to be generated when vibrating an operation unit and to stabilize vibration of the operation unit.

According to a first aspect of the disclosure, there is provided an input device configured to receive a user's touch operation and to output a control signal. The input device includes a first plate configured to receive the user's touch operation, a vibrator configured to vibrate the first plate, and a second plate fixed with a predetermined interval between the first plate and the second plate and configured to support the first plate.

By the above configuration, since the first plate is supported by the second plate, it is possible to make the first plate thin and to suppress a noise when vibrating the first plate.

According to a second aspect of the disclosure, there is provided an input device including an operation unit having an operation surface, a detecting unit configured to detect a user's touch operation on the operation surface, a vibrating element configured to vibrate the operation unit, and a vibration control unit configured to control vibration of the vibrating element on the basis of the touch operation detected by the detecting unit, wherein the operation unit has a first region having the operation surface and a second region provided at a periphery of the first region and having rigidness greater than rigidness of the first region.

According to the first aspect, even when a plate thickness of the operation surface is made to be thin so as to suppress the noise, it is possible to suppress damage of the operation surface.

According to the second aspect, it is possible to reduce the noise that is to be generated when vibrating the operation unit and to stabilize the vibration of the operation unit.

### BRIEF DESCRIPTION OF THE DRAWINGS

Exemplary embodiments of the present invention will be described in detailed based on the following figures, wherein:

FIG. 1 is a block diagram depicting a configuration of a system including a touch input device in accordance with a first illustrative embodiment of the disclosure;

FIG. 2 is a sectional view of a panel part;

FIG. 3 is an exploded perspective view of an operation unit;

FIG. 4 depicts a positional relation among a vibrator, a vibration panel and a support panel;

FIG. 5 illustrates positions at which the vibration panel can be vibrated;

FIG. 6 depicts an operation flow of the touch input device;

FIG. 7 illustrates a change in tactile sense;

FIG. 8 depicts a region in which the tactile sense is to be changed;

FIG. 9 illustrates an outline of an input device in accordance with a second illustrative embodiment of the disclosure;

FIG. 10 illustrates a configuration of a display device in accordance with the second illustrative embodiment of the disclosure;

FIG. 11 illustrates a first arrangement example of a display unit;

FIG. 12 illustrates a second arrangement example of the display unit;

FIG. 13A is a plan view illustrating a first configuration example of an operation unit;

FIG. 13B is a side view illustrating the first configuration example of the operation unit;

FIG. 14A is a plan view illustrating a second configuration example of the operation unit;

FIG. 14B is a side view illustrating the second configuration example of the operation unit;

FIG. 15A is a plan view illustrating a third configuration example of the operation unit; and

FIG. 15B is a side view illustrating the third configuration example of the operation unit.

### DETAILED DESCRIPTION

Hereinafter, illustrative embodiments of the disclosure will be described with reference to the drawings. The configurations of the illustrative embodiments are just exemplary and the disclosure is not limited to the configurations of the illustrative embodiments.

### First Illustrative Embodiment

<Apparatus Configuration>

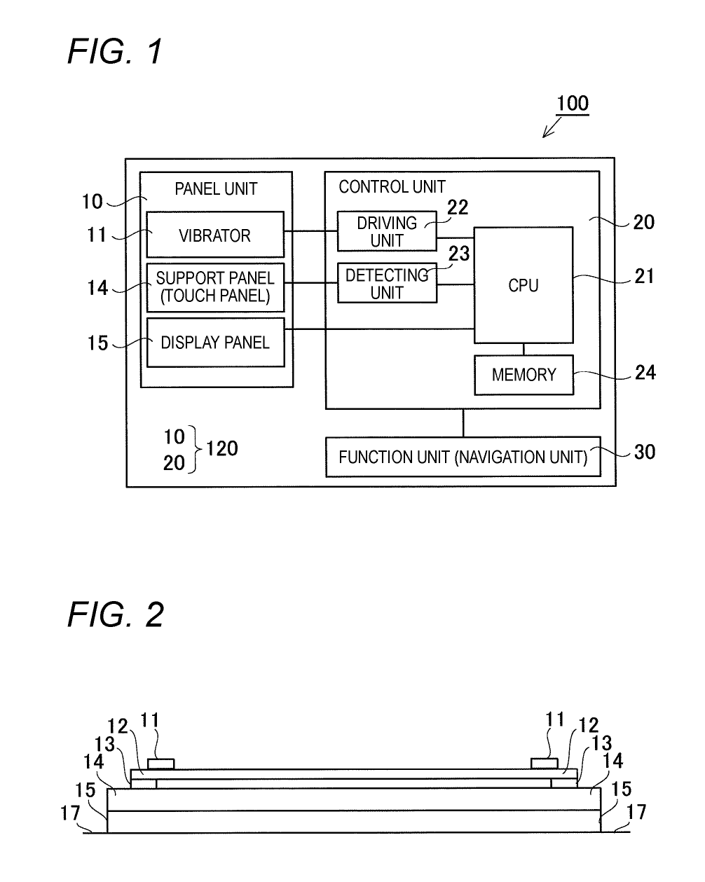

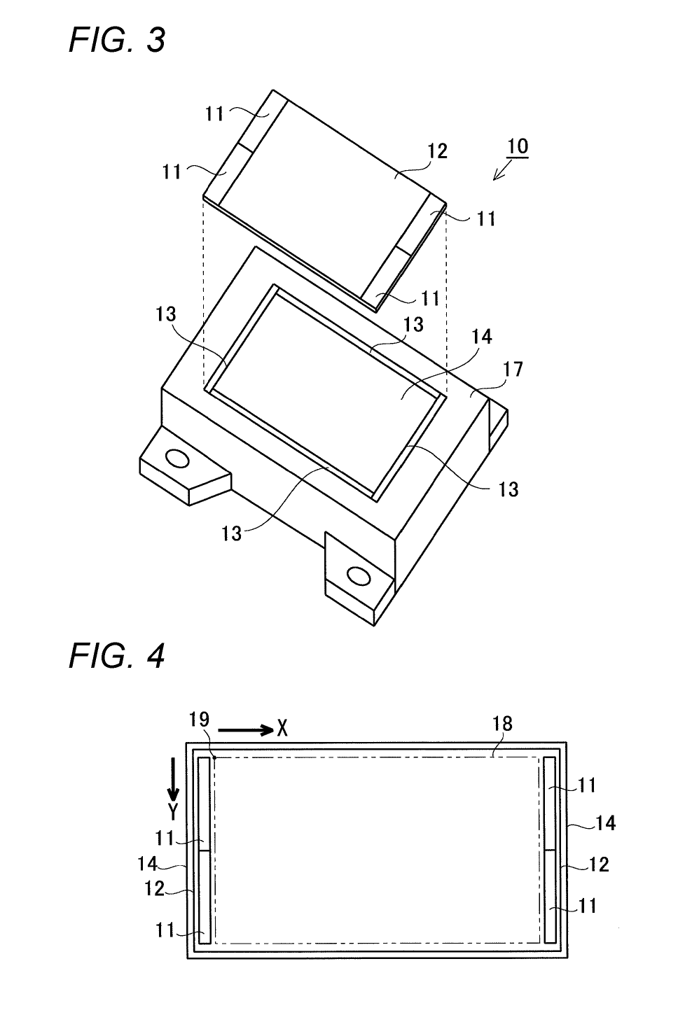

FIG. 1 is a block diagram depicting a configuration of a system including a touch input device in accordance with a first illustrative embodiment, FIG. 2 is a sectional view of a panel part, and FIG. 3 is an exploded perspective view of an operation unit.

As shown in FIG. 1, the system 100 includes a panel unit 10, a control unit 20 and a function unit 30. The panel unit 10 is configured to receive a user's touch operation, to input a signal indicative of a touch position to the control unit 20, to vibrate an operation surface in response to control of the control unit 20, and to provide a user with a predetermined tactile sense. Also, the panel unit 10 may have a display panel 15 configured to make a display for the user.

The control unit 20 is configured to control the panel unit 10. For example, the control unit is configured to vibrate the operation surface in correspondence to a touch position of the user and to provide the user with a tactile sense corresponding to the touch position. Also, the control unit is configured to generate a control signal in correspondence to the user's touch operation received at the panel unit 10 and to output the same to the function unit 30. Also, when the panel unit 10 has the display panel 15, the control unit 20 transmits image information acquired from the function unit to the panel unit 10 for displaying the same.

In the first illustrative embodiment, the panel unit 10 and the control unit 20 configure a touch input device 120. The function unit 30 is configured to execute a function, in response to a control signal from the touch input device 120. For example, when the system 100 is a navigation system, the system has the function unit 30 configured to execute a navigation function, and the function unit executes navigation functions such as calculation of a path to a destination, a path display and the like, in response to the control signal from the touch input device 120. Also, the disclosure is not limited thereto, and the function unit 30 may be configured to execute functions of an audio and an air conditioner. That is, the system 100 may be a device having the touch input device 120 as an operation unit of the audio or a device having the touch input device 120 as an operation unit of the air conditioner.

Subsequently, the panel unit 10 is described in detail. As shown in FIGS. 2 and 3, the panel unit 10 has vibrators 11, a vibration panel 12, a spacer 13, a support panel 14 and a display panel 15.

The vibration panel 12 is a first plate configured to be vibrated by the vibrators 11 and to provide a predetermined tactile sense to a user who is performing a touch operation. The vibration panel 12 is positioned at a side (outer side) of the panel unit 10 closest to the user, and a surface of the user-side is configured as an operation surface configured to receive a user's touch operation. The vibration panel 12 has a flat plate shape and a plate thickness thereof is smaller than the support panel 14. The plate thickness of the vibration panel 12 is 0.1 to 1 mm or 0.1 to 0.5 mm, for example, and is 0.3 mm, in the first illustrative embodiment. As a material of the vibration panel 12, glass or plastic may be exemplified. However, the material is not particularly limited. In the meantime, when the panel unit 10 has the display panel 15, the vibration panel 12 is made of a transparent material such as glass, acryl or the like.

The vibrator 11 is an element such as a piezo element configured to vibrate the vibration panel 12, in response to a driving signal from the control unit 20.

The support panel 14 is a second plate fixed with a predetermined interval between the vibration panel 12 and the support panel and configured to support the vibration panel 12. A plate thickness of the support panel 14 is 0.5 to 5 mm or 1 to 3 mm, for example, and is 1.1 mm, in the first illustrative embodiment. As a material of the support panel 14, glass or plastic may be exemplified. However, the material is not particularly limited. In the meantime, when the panel unit 10 has the display panel 15, the vibration panel 12 is made of a transparent material such as glass, acryl or the like.

The spacer 13 is a member for securing the interval between the vibration panel 12 and the support panel 14. That is, the spacer 13 is interposed between the vibration panel 12 and the support panel 14, so that the vibration panel 12 and the support panel 14 are fixed in substantially parallel with each other with the interval corresponding to a thickness of the spacer 13. In the meantime, the interval is 0.1 to 2 mm or 0.1 to 1 mm, for example, and is 0.4 mm, in the first illustrative embodiment. In the first illustrative embodiment, the vibration panel 12 and the support panel 14 are arranged in parallel with each other, and the interval between the vibration panel 12 and the support panel 14 is uniformly set at any position in a plane. However, the vibration panel 12 and the support panel 14 are not necessarily to be arranged in strictly parallel with each other. For example, the interval between the vibration panel 12 and the support panel 14 may be different by about ±50%, depending on positions in the plane. In other words, the vibration panel 12 and the support panel 14 may be slightly spaced so that the vibration of the vibration panel 12 is not transmitted to the support panel 14, and the support panel 14 may be arranged at a distance in which when the vibration panel 12 is bent by a touch operation, the vibration panel 12 is not damaged by the bending so that the vibration panel 12 is supported with being contacted to the support panel 14.

Also, the spacer 13 may have a function of a filter (insulator) configured to suppress the vibration of the vibration panel 12 from being transmitted to the support panel 14. For example, the spacer 13 may have a configuration where the spacer is configured by an elastic member and absorbs the vibration to suppress the vibration to be transmitted to the support panel 14.

In the first illustrative embodiment, the spacer 13 is a double-sided tape having adhesive layers on adhesion surfaces with the vibration panel 12 and the support panel 14, and is bonded in a square shape along a peripheral edge of the support panel 14 held in a housing 17, as shown in FIG. 3. A backside peripheral edge of the vibration panel 12 is bonded to the double-sided tape, i.e., the spacer 13, so that the vibration panel 12 and the support panel 14 are partially bonded to each other at end portions. That is, the vibration panel 12 and the support panel 14 are bonded to each other only at the peripheral edges along which the spacer 13 is arranged, and an inside of the square formed by the spacer 13 is an empty space without being bonded.

Also, in the first illustrative embodiment, the support panel 14 is a touch panel configured to detect a user's touch position. For example, the support panel is configured to detect a position touched by the user and to notify the control unit 20 of a signal indicative of the detected position by a well-known method such as a resistance film method or an electrostatic capacitance method. In the meantime, the disclosure is not limited to the configuration where the touch panel is integrated with the support panel 14. For example, the touch panel may be arranged on a backside of the support panel 14, separately from the support panel 14.

FIG. 4 depicts a positional relation among the vibrators 11, the vibration panel 12 and the support panel 14. As shown in FIG. 4, the vibrators 11 and the vibration panel 12 have a rectangular shape, as seen from above, respectively, and are arranged so that long sides of the vibrators 11 follow short sides of the vibration panel 12. A rectangular part of a surface of the vibration panel 12, which is located at inner sides of the vibrators 11, is configured as an operation region 18. When the user touches the operation region 18, the touch position is detected by the support panel (touch panel) 14. For example, one (a left-upper apex in FIG. 4) of apexes of the operation region 18 is set as an origin, and the touch position is detected as coordinates in a longitudinal direction (an X-axis direction in FIG. 4) of the vibration panel 12 and in a width direction (a Y-axis direction in FIG. 4) of the vibration panel 12.

Subsequently, the control unit 20 is described in detail. As shown in FIG. 1, the control unit 20 has a CPU 21, a driving unit 22, a detecting unit 23 and a memory 24.

The detecting unit 23 is configured to acquire a signal indicative of a user's touch position from the support panel (touch panel) 14 and to input the same to the CPU 21.

The memory 24 includes a main storage device and an auxiliary storage device. The main storage device is used as a work area of the CPU 21, a storing area of program and data and a buffer area of communication data. The main storage device is configured by a Random

Access Memory (RAM) or a combination of a RAM and a Read Only Memory (ROM), for example.

The CPU 21 is also referred to as an MPU (Micro Processor Unit), a microprocessor, a processor or a processing device. The CPU 21 is not limited to a single processor and may have a multi-processor configuration. Also, a single CPU connected with a single socket may have a multi-core configuration. At least some processing of the respective units may be performed by a processor except for the CPU, for example, a dedicated processor such as a Digital Signal Processor (DSP), a Graphics Processing Unit (GPU), a numeric calculation processor, a vector processor, an image processing processor or the like. Also, at least some processing of the respective units may be performed by an integrated circuit (IC) or other digital circuit. Also, at least some of the respective units may include an analog circuit. The integrated circuit includes an LSI, an Application Specific Integrated Circuit (ASIC) and a programmable logic device (PLD). The PLD includes a Field-Programmable Gate Array (FPGA), for example. Each unit may be a combination of a processor and an integrated circuit. The combination is also referred to as an MCU (Micro Controller Unit), a SoC (System-on-a-chip), a system LSI, a chipset or the like.

The CPU 21 is configured to load a program stored in the memory 24 into the main storage device and to execute the same. In the memory 24, programs such as an operating system, firmware and the like are installed.

The CPU 21 functions as a tactile sense instruction unit configured to determine a tactile sense to be provided to the user in correspondence to a user's touch position and to notify the driving unit 22 of an instruction signal for enabling vibration to provide the tactile sense by executing a program.

Also, the CPU 21 functions as a display control unit configured to display an image on the display panel 15 on the basis of an image signal acquired from the function unit 30. Also, the CPU 21 functions as a signal input unit configured to input a control signal, which indicates the touch position acquired from the detecting unit 23, to the function unit 30.

The driving unit 22 is configured to drive the vibrators 11 on the basis of the instruction signal from the CPU 21. For example, the driving unit is configured to supply the vibrators 11 with driving current modulated so as to vibrate the vibrators 11 with a frequency exceeding a human audible range and to thereby enable the vibration panel 12 to vibrate with a natural frequency Fo. In the meantime, the vibrations of the vibrators 11 and the vibration panel 12 are not limited to the frequency exceeding the human audible range, and may be within the human audible range.

<Manufacturing Method>

Subsequently, a method of manufacturing the touch input device 120 is described. The touch input device 120 is configured to resonate the vibration panel 12 by the vibration of the vibrators 11, thereby providing the user with a clear tactile sense. To this end, the vibrators 11 are arranged at positions of surface end portions of the vibration panel 12, at which the vibration panel 12 can be resonated.

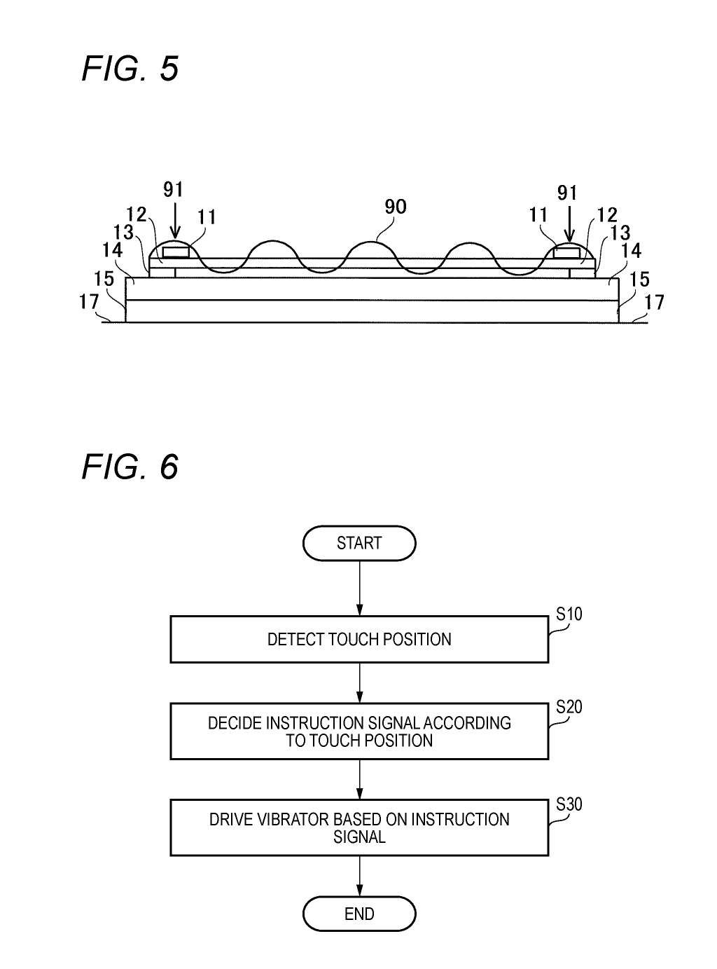

The positions at which the vibration panel 12 can be resonated are obtained by a following method, for example. FIG. 5 illustrates positions 91 at which the vibration panel 12 can be resonated. First, an eigenvalue analysis is performed on the basis of properties of the vibration panel 12 such as a longitudinal length, a width, a thickness, a density and the like of a planar shape of the vibration panel 12, so that a natural frequency of the vibration panel 12 is obtained. Then, when a stationary wave 90 progressing in a longitudinal direction of the vibration panel 12 is generated by vibrating the vibration panel 12 with the natural frequency, positions of anti-nodes occurring between a node and a node of the stationary wave, i.e., positions at which an amplitude of the stationary wave is greatest are obtained. Then, the vibrators 11 are temporarily put at longitudinal end portions of the vibration panel 12, at which the amplitude of the stationary wave is greatest, and positions of the vibrators 11 are finely adjusted in the longitudinal direction of the vibration panel 12. For example, positions of end portions or central portions of the vibrators 11 relative to the positions of the anti-nodes are adjusted and positions at which the vibration panel 12 can be best vibrated are obtained as the positions 91.

In this way, the longitudinal positions of the vibration panel 12 are obtained as the positions 91 at which the vibration panel 12 can be vibrated, and the vibrators 11 are arranged in a short side direction (width direction) of the vibration panel 12.

Then, a surface peripheral edge of the support panel 14 held in the housing 17 and a backside peripheral edge of the vibration panel 12 are bonded to each other via the spacer 13, so that the touch input device 120 is manufactured.

<Operations of Touch Input Device>

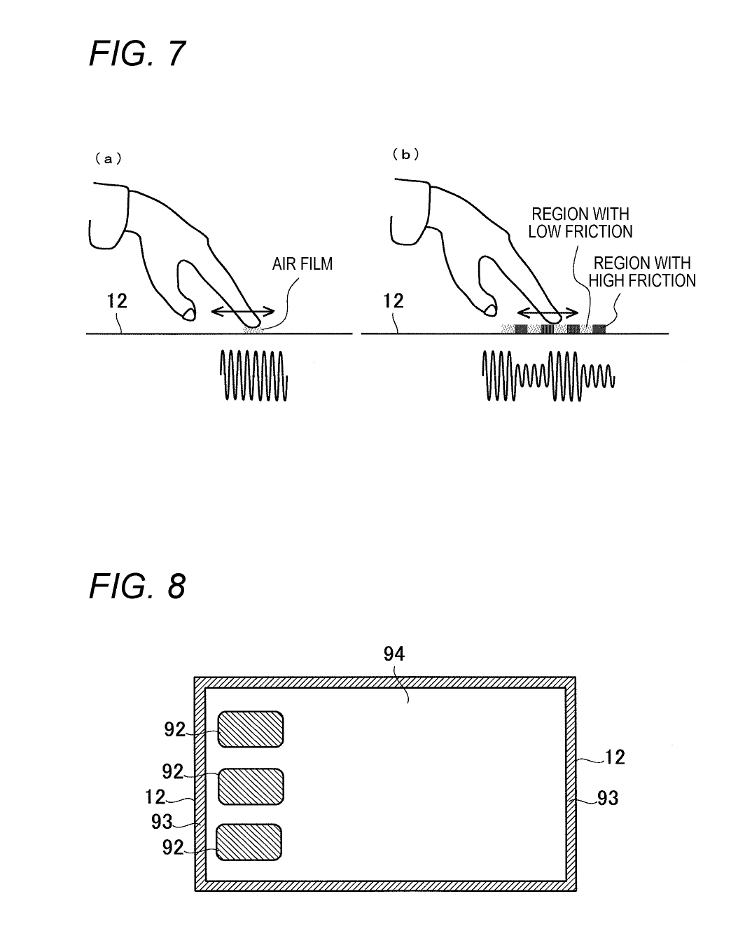

Subsequently, an operation in which the user is provided with the tactile sense by the touch input device 120 is described. FIG. 6 depicts an operation flow of the touch input device 120, FIG. 7 illustrates a change in the tactile sense, and FIG. 8 depicts a region in which the tactile sense is to be changed.

When a power supply becomes on or a start instruction from the user or the like is received, the touch input device 120 starts processing of FIG. 6. First, the touch input device 120 obtains a user's touch position by the support panel (touch panel) 14 (step S10).

Then, the touch input device 120 determines an instruction signal indicative of how to vibrate the vibration panel 12, based on the user's touch position (step S20). The instruction signal is a signal for defining states of the vibration, such as a signal for vibrating the vibration panel 12 with the frequency Fo at which the vibration panel 12 is to resonate and with a constant amplitude, a signal for intermittently changing an amplitude of the frequency Fo and a signal for defining the amplitudes to specific magnitudes. In the meantime, a condition, which indicates which instruction signal is to be determined with respect to which touch position, is beforehand stored as a data table in the memory 24, for example, and an instruction signal corresponding to the touch position acquired in step S10 is read. In the meantime, the instruction signal may include an instruction for stopping the vibration.

Then, the touch input device 120 sends the instruction signal to the driving unit 22, and feeds driving power modulated in correspondence to the instruction signal to the vibrators 11, thereby vibrating the vibration panel 12 (step S30). In the meantime, the processing of FIG. 6 is periodically executed until the power supply becomes off or a stop instruction is issued. Thereby, when the user changes the touch position so as to trace the operation surface, the vibration state of the vibration panel 12 is changed in correspondence to the touch position, so that the tactile sense is made different. For example, when the vibration panel 12 is vibrated with the frequency Fo and with a constant amplitude, it is possible to provide a slick tactile sense of low frictional resistance as if there were a high-pressure air layer between a finger tip of the user who is tracing the operation surface of the vibration panel 12 and the operation surface, as shown in FIG. 7(a). Also, when an amplitude of the frequency Fo is intermittently changed, a portion of low frictional resistance and a portion of high frictional resistance are intermittently provided for the finger tip of the user who is tracing the operation surface of the vibration panel 12, as shown in FIG. 7(b), so that it is possible to provide an asperate tactile sense.

In this way, the touch input device 120 of the first illustrative embodiment is configured to switch the tactile sense by the touch position, thereby presenting tactile senses of a button (soft key) position of the operation region and a boundary of the operation region by specific tactile senses.

For example, the tactile senses that are to be presented in an object 92 such as a button, an icon or the like in an operation region shown in FIG. 8, a boundary 93 of the operation region and a marginal part 94 except for the object 92 within the boundary 93 are switched. In the example of FIG. 8, when the touch positions are located at the object 92 and the boundary 93, the vibration of the vibration panel 12 is intermittently modulated, and when the touch position is located at the marginal part 94, the vibration panel 12 is constantly vibrated. Thereby, when the user touches the positions of the object 92 and the boundary 93, an asperate tactile sense is presented, and when the user touches the position of the marginal part 94, a slick tactile sense is presented. In the meantime, the tactile sense may be changed by making the magnitudes of the amplitudes or timings, at which the amplitude is to be intermittently changed, at the object 92 and the boundary 93 different. For this reason, while the user is driving, even though the user does not keep observation on the operation surface, the user can perceive the position of the object 92 and the boundary 93 of the operation region by the tactile senses, so that the user can operate the function unit such as a navigation unit.

### Operations and Effects of First Illustrative Embodiment

As described above, according to the first illustrative embodiment, the vibration panel 12 configured to receive the user's touch operation, the vibrators 11 configured to vibrate the vibration panel 12, and the support panel 14 fixed with a predetermined interval from the vibration panel 12 and configured to support the vibration panel 12 are provided.

By the above configuration, since the vibration panel 12 is supported by the support panel 14, it is possible to make the vibration panel 12 thin and to suppress a noise when vibrating the vibration panel 12. At this time, the vibrators 11 and the vibration panel 12 are vibrated with the frequency higher than the human audible range, so that it is possible to present the tactile sense without causing the user to feel the vibration as sound. In the meantime, the disclosure is not limited thereto. For example, the vibrators 11 and the vibration panel 12 may be vibrated with a frequency within the human audible range. In this way, even though the sound is generated as the vibrators 11 and the vibration panel 12 are vibrated with a frequency within the human audible range, the vibration panel 12 is made thin, so that a sound pressure level is lowered upon the vibration of the vibration panel 12. Therefore, it is possible to suppress the noise associated with the sound.

Also, according to the input device of the first illustrative embodiment, the end portions of the vibration panel 12 are provided with the vibrators 11, and the support panel 14 and the vibration panel 12 are partially bonded to each other in the vicinity of the end portions.

By the above configuration, even when the vibration panel 12 is vibrated, the vibration is suppressed from being transmitted to the support panel 14, so that it is possible to suppress the noise.

Also, according to the input device of the first illustrative embodiment, the vibrators 11 are arranged at the positions at which the amplitude of the stationary wave is greatest when the stationary wave is generated in the vibration panel 12 by the vibrators 11.

By the above configuration, it is possible to efficiently vibrate the vibration panel 12, thereby clearly presenting the tactile sense.

Also, according to the input device of the first illustrative embodiment, the vibration panel 12 and the vibrators 11 have a rectangular planar shape, respectively, and the vibrators 11 are arranged so that the long sides thereof follow the short sides of the vibration panel 12.

By the above configuration, the vibration panel 12 is efficiently vibrated by causing the vibration so as to progress in a direction (longitudinal direction) along which the vibration panel 12 is likely to vibrate, so that it is possible to clearly present the tactile sense.

Also, the input device of the first illustrative embodiment includes the touch panel (support panel) configured to detect the user's touch position and the control unit 20 configured to change the vibration by the vibrators 11 in correspondence to the touch position.

By the above configuration, it is possible to change the tactile sense in correspondence to the user's touch position and to enable the user to recognize the touch position by the change in the tactile sense. For example, when the object in the operation region is touched or the boundary of the operation region is touched, the specific tactile sense is presented, so that it is possible to enable the user to recognize the touch of the corresponding part.

Also, the system of the first illustrative embodiment includes the touch input device 120 and the function unit 30 configured to implement the function corresponding to the touch position detected at the touch panel.

By the above configuration, the user can perceive the position of the object 92 and the boundary 93 of the operation region by the tactile senses without keeping observation on the operation surface and can operate the function unit 30.

Also, according to the method of manufacturing the input device of the first illustrative embodiment, the vibrators 11 configured to vibrate the vibration panel 12 are arranged at the end portions of the vibration panel 12 configured to receive the user's touch operation, and the support panel 14 configured to support the vibration panel 12 and the vibration panel 12 are bonded to each other with the predetermined interval in the vicinity of the end portions.

By the above configuration, it is possible to make the vibration panel 12 thin, so that it is possible to manufacture the touch input device capable of suppressing the noise upon the vibration of the vibration panel 12.

Although the first illustrative embodiment of the disclosure has been described, the illustrative embodiment is just exemplary and is not intended to limit the disclosure, and a variety of changes can be made on the basis of the knowledge of one skilled in the art without departing from the gist of the claims.

### Second Illustrative Embodiment

[Outline of Input Device]

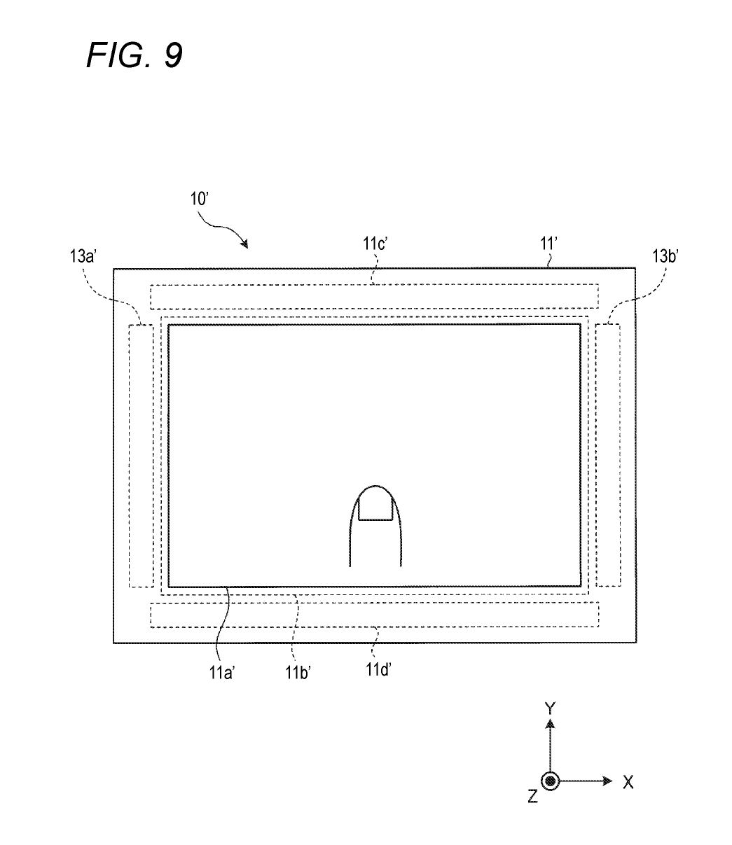

An outline of the input device in accordance with a second illustrative embodiment of the disclosure is described with reference to FIG. 9. FIG. 9 illustrates an outline of an input device 10′ of the second illustrative embodiment of the disclosure.

FIG. 9 depicts a three dimensional Cartesian coordinate system including X, Y and Z axes. The three dimensional Cartesian coordinate system may be shown in the other drawings, too. A positive direction and a negative direction of the Z axis shown in FIG. 9 correspond to a front side and an inner side of the drawing sheet of FIG. 9, respectively.

The input device 10′ is a position input device included in a vehicular touch panel that is to be mounted on a car navigation system, for example. The input device 10′ includes an operation unit 11′, a first vibrating element 13a′ and a second vibrating element 13b′.

The operation unit 11′ has an operation surface 11a′. The operation unit 11′ is a touch pad, for example. The operation surface 11a′ is a substantially rectangular surface provided at a substantial center of the operation unit 11′.

The first vibrating element 13a′ and the second vibrating element 13b′ are respectively configured to vibrate the operation unit 11′. Each of the first vibrating element 13a′ and the second vibrating element 13b′ is a piezoelectric actuator, for example. The first vibrating element 13a′ and the second vibrating element 13b′ are arranged to sandwich the operation surface 11a′ therebetween and to extend in a short side direction of the substantially rectangular shape of the operation surface 11a′, i.e., in the Y-axis direction.

For example, when a touch operation on the operation surface 11a′ is performed by a user's finger, the input device 10′ detects the user's touch operation on the operation surface 11a′. Thereby, the input device 10′ receives an input operation from the user.

Also, the input device 10′ is configured to control vibrations of the first vibrating element 13a′ and the second vibrating element 13b′, based on the detected user's touch operation. Thereby, the input device 10′ can control the vibration of the operation unit 11′, in correspondence to the user's touch operation. As a result, the input device 10′ can present the user with a tactile sense corresponding to the user's touch operation.

The operation unit 11′ further has a first region 11b′ and second regions 11c′, 11d′. The first region 11b′ has the operation surface 11a′. The second regions 11c′, 11d′ are respectively provided at the periphery of the first region 11b′ and have rigidness higher than rigidness of the first region 11b′.

The first region 11b′ is a substantially rectangular region including the operation surface 11a′, for example, and sandwiched between the first vibrating element 13a′ and the second vibrating element 13b′. The first region 11b′ is configured to be vibrated by the first vibrating element 13a′ and the second vibrating element 13b′.

Each of the second regions 11c′, 11d′ is a substantially rectangular region provided at the periphery of the first region 11b′. Long sides of the substantially rectangular shape of each of the second regions 11c′, 11d′ are provided in a direction substantially parallel with long sides of the substantially rectangular shape of the first region, i.e., in the X-axis direction.

Herein, when a thickness of a vibration plate configuring the operation unit 11′ is reduced so as to reduce the noise that is to be generated when vibrating the operation unit 11′, the rigidness of the operation unit 11′ is reduced. Also in this case, the operation unit 11′ has the second regions 11c′, 11d′ having the rigidness higher than the rigidness of the first region 11b′, so that it is possible to provide the operation unit 11′ with rigidness. Thereby, it is possible to stably vibrate the operation unit 11′.

In this way, according to the input device 10′, it is possible to reduce the noise that is to be generated when vibrating the operation unit 11′ and to stably vibrate the operation unit 11′.

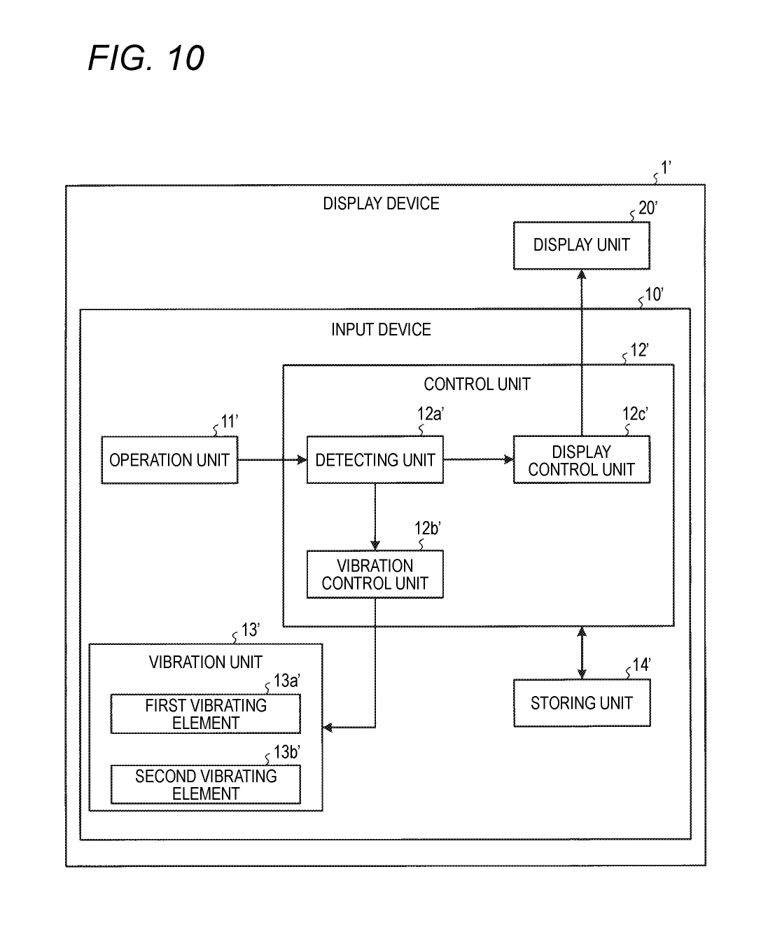

Subsequently, a display device in accordance with the second illustrative embodiment, which includes the input device 10′, is described with reference to FIG. 10. FIG. 10 illustrates a configuration of a display device 1′ in accordance with the second illustrative embodiment.

[Display Device 1′]

The display device 1′ is a touch panel used for a monitor for a car navigation system to be mounted on a vehicle, a smart phone or a tablet terminal, for example. The display device 1′ includes the input device 10′ and a display unit 20′.

[Input Device 10′]

The input device 10′ is a position input device that is to be included in the touch panel, for example. The input device 10′ is configured to receive an input operation from a user and to output a signal corresponding to the user's input operation to the display unit 20′. The input device 10′ includes an operation unit 11′, a control unit 12′, a vibration unit 13′ and a storing unit 14′.

[Operation Unit 11′]

The operation unit 11′ is a touch pad used for the touch panel, for example. The touch pad has a sensor having a flat plate shape and configured to receive a user's touch operation by a change in electrostatic capacitance, for example.

The operation unit 11′ has the operation surface 11a′ configured to receive the user's touch operation. For example, when the user performs the touch operation on the operation surface 11a′ by using a finger or a pointing device such as a touch pen, the operation unit 11′ outputs a signal corresponding to the user's touch operation on the operation surface 11a′ to the control unit 12′. In the meantime, the configuration of the operation unit 11′ will be separately described in detail later.

[Control Unit 12′]

The control unit 12′ is configured to control the respective units included in the input device 10′. The control unit 12′ is configured to read or write data from or to the storing unit 14′ on the basis of the signal corresponding to the user's touch operation received via the operation surface 11a′ of the operation unit 11′ and to output the reading or writing signal to the vibration unit 13′ and the display unit 20′. The control unit 12′ is a CPU (Central Processing Unit) of a computer, for example. The control unit 12′ has a detecting unit 12a′, a vibration control unit 12b′ and a display control unit 12c′.

[Detecting Unit 12a′]

The detecting unit 12a′ is configured to detect the user's touch operation on the operation surface 11a′ of the operation unit 11′, based on the signal output from the operation unit 11′. When the user's touch operation on the operation surface 11a′ is detected, the detecting unit 12a′ outputs a signal corresponding to a detection result of the user's touch operation to the vibration control unit 12b′ and the display control unit 12c′.

[Vibration Control Unit 12b′]

The vibration control unit 12b′ is configured to control the vibrations of the first vibrating element 13a′ and the second vibrating element 13b′ included in the vibration unit 13′, based on the signal output from the detecting unit 12a′, i.e., the touch operation detected by the detecting unit 12a′.

The vibration control unit 12b′ is configured to output voltage signals corresponding to the vibrations of the first vibrating element 13a′ and the second vibrating element 13b′ to the vibration unit 13′.

The vibration control unit 12b′ can vibrate the first vibrating element 13a′ and the second vibrating element 13b′ with an ultrasonic frequency band, for example. In this case, an air layer is formed between the user's finger and the operation surface 11a′, so that a frictional force between the user's finger and the operation surface 11a′ is reduced. As a result, the user can feel the smoother tactile sense on the operation surface 11a′ by the reduced frictional force between the user's finger and the operation surface 11a′.

For example, when the detecting unit 12a′ detects pressing or movement of the user's finger on the operation surface 11a′, the vibration control unit 12b′ can control the vibrations of the first vibrating element 13a′ and the second vibrating element 13b′ with the ultrasonic frequency band. Thereby, it is possible to control the frictional force between the user's finger and the operation surface 11a′. As a result, the input device 10′ can control the user's tactile sense on the operation surface 11a′.

In the meantime, although the vibration control unit 12b′ is configured to vibrate the first vibrating element 13a′ and the second vibrating element 13b′ with the ultrasonic frequency band, the vibration control unit 12b′ may be configured to vibrate the first vibrating element 13a′ and the second vibrating element 13b′ with a frequency lower than the ultrasonic frequency band. In this case, the input device 10′ can present the user with the tactile sense of the vibration.

[Display Control Unit 12c′]

The display control unit 12c′ is configured to output a signal corresponding to information, which is to be displayed on the display unit 20′, based on the signal output from the detecting unit 12a′.

[Vibration Unit 13′]

The vibration unit 13′ has at least one vibrating element configured to vibrate the operation unit 11′, for example, the first vibrating element 13a′ and the second vibrating element 13b′.

Each of the first vibrating element 13a′ and the second vibrating element 13b′ is a piezoelectric actuator having a piezoelectric element (piezo element). In this case, each of the first vibrating element 13a′ and the second vibrating element 13b′ is configured to expand and contract on the basis of the voltage signals output from the control unit 12′, thereby vibrating the operation unit 11′.

Each of the first vibrating element 13a′ and the second vibrating element 13b′ is provided to contact the operation unit 11′. The first vibrating element 13a′ and the second vibrating element 13b′ are provided so that waves to be generated by the first vibrating element 13a′ and the second vibrating element 13b′ overlap to form a stationary wave. For example, as shown in FIG. 9, each of the first vibrating element 13a′ and the second vibrating element 13b′ are provided to sandwich the operation surface 11a′ therebetween and to extend in a direction perpendicular to a propagation direction of waves for vibrating the operation unit 11′.

Although the vibration unit 13′ includes the first vibrating element 13a′ and the second vibrating element 13b′ provided to sandwich the operation surface 11a′ therebetween, the number and arrangement of the vibrating elements included in the vibration unit 13′ are not particularly limited. For example, the number of the vibrating elements included in the vibration unit 13′ may be one. Also, for example, the two vibrating elements may be arranged at each of both end portions of the operation surface 11a′ or the two vibrating elements may be arranged only at one end portion of the operation surface 11a′.

Also, although each of the first vibrating element 13a′ and the second vibrating element 13b′ is configured by the piezoelectric actuator, each of the first vibrating element 13a′ and the second vibrating element 13b′ is not limited to the piezoelectric actuator. For example, each of the first vibrating element 13a′ and the second vibrating element 13b′ may be an element capable of vibrating the operation unit 11′ with an ultrasonic frequency.

[Storing Unit 14′]

The storing unit 14′ is configured to store therein information, which is necessary for processing to be executed by the respective units included in the input device 10′, and/or results of processing to be executed by the respective units included in the input device 10′.

The storing unit 14′ is configured to store therein data relating to the user's touch operation and control data of the vibrating elements and information to be displayed on the display unit 20′, which are associated with the data relating to the user's touch operation, for example. The information to be displayed on the display unit 20′ may be images for navigation of a vehicle such as a map or image data such as moving or still images of a television or internet, for example.

The storing unit 14′ is a semiconductor memory device such as a RAM (Random Access Memory), a ROM (Read Only Memory) or a flash memory or a storage device such as a hard disk or an optical disk.

[Display Unit 20′]

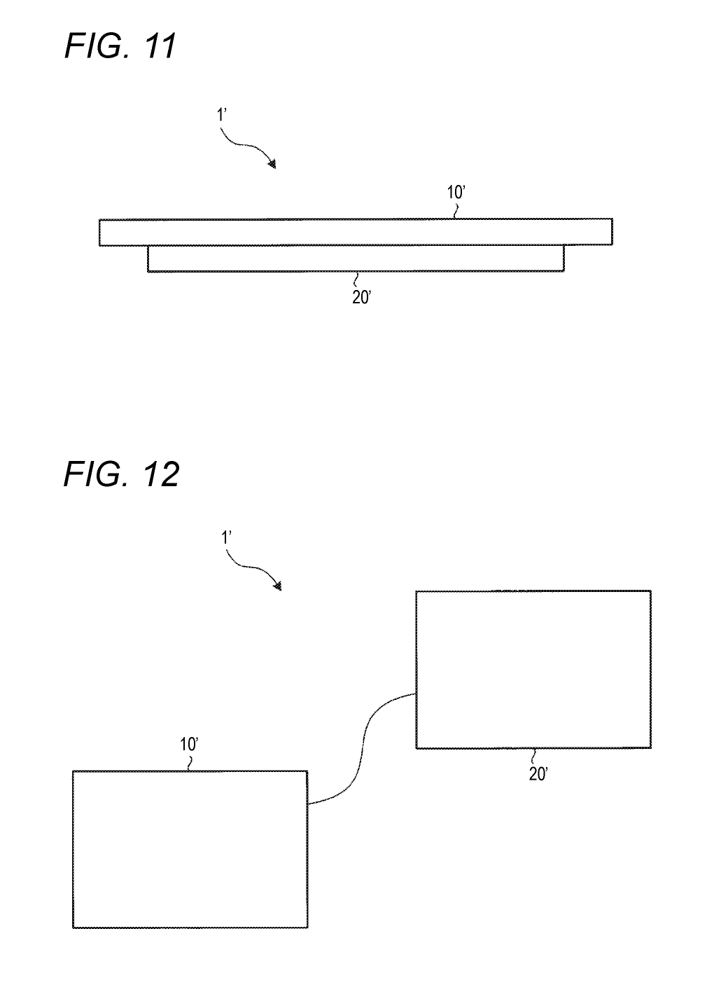

The display unit 20′ is configured to display the information on the basis of the signal output from the display control unit 12c′, i.e., on the basis of the touch operation detected by the detecting unit 12a′ included in the input device 10′. The display unit 20′ is a liquid crystal monitor, for example. The display unit 20′ is configured to present the user with the information. FIG. 11 illustrates a first arrangement example of the display unit 20′. In the example of FIG. 11, the display unit 20′ is provided integrally with the input device 10′. The input device 10′ and the display unit 20′ are arranged so that the operation surface 11a′ of the operation unit 11′ included in the input device 10′ faces a display region of the display unit 20′. The operation surface 11a′ of the operation unit 11′ is formed of a light transmitting material. In this case, the user can visibly recognize the information displayed in the display region of the display unit 20′ through the operation surface 11a′.

FIG. 12 illustrates a second arrangement example of the display unit 20′. In the example of FIG. 12, the display unit 20′ is provided separately from the input device 10′. The input device 10′ is configured to perform communication with the display unit 20′ in a wired or wireless manner. The input device 10′ and the display unit 20′ are configured so that a specific position on the operation surface 11a′ of the operation unit 11′ included in the input device 10′ corresponds to a specific position in the display region of the display unit 20′.

[First Configuration Example of Operation Unit 11′]

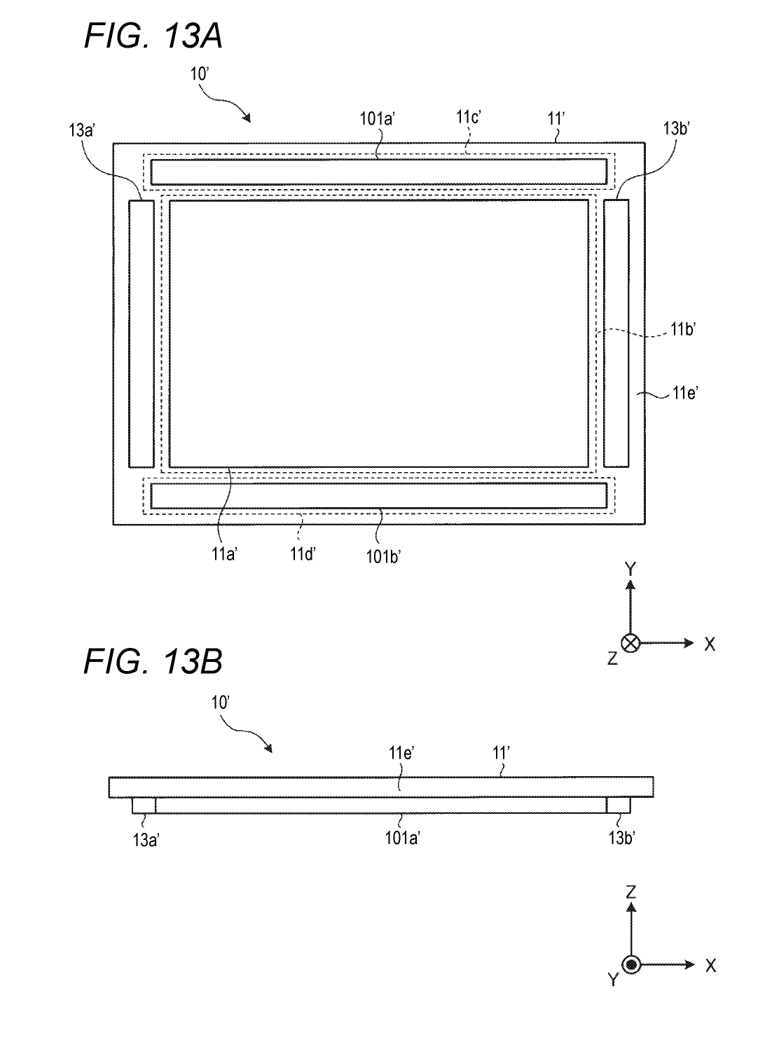

Subsequently, a first configuration example of the operation unit 11′ shown in FIG. 9 is described with reference to FIGS. 13A and 13B. FIG. 13A is a plan view illustrating the first configuration example of the operation unit 11′. FIG. 13B is a side view illustrating the first configuration example of the operation unit 11′. A positive direction and a negative direction of the Z-axis shown in FIG. 13A correspond to a front side and an inner side of the drawing sheet of FIG. 13A, respectively.

The constitutional elements of the operation unit 11′ shown in FIGS. 13A and 13B, which are the same or similar as or to the constitutional elements of the operation unit 11′ shown in FIGS. 9, are denoted with the same reference numerals as those of FIG. 9, and the descriptions thereof are omitted or simplified. Also, in the example shown in FIGS. 13A and 13B, the first vibrating element 13a′ and the second vibrating element 13b′ are also shown for convenience of descriptions.

The operation unit 11′ shown in FIGS. 13A and 13B has the operation surface 11a′. Each of the first vibrating element 13a′ and the second vibrating element 13b′ is configured to vibrate the operation unit 11′. The waves of vibrating the operation unit 11′, which are generated by first vibrating element 13a′ and the second vibrating element 13b′, propagate in the long side direction of the substantially rectangular shape of the operation surface 11a′, i.e., in the X-axis direction.

The operation unit 11′ has the first region 11b′ and the second region 11c′, 11d′. The first region 11b′ has the operation surface 11a′.

Each of the second regions 11c′, 11d′ is provided at the periphery of the first region 11b′ and has the rigidness higher than the rigidness of the first region 11b′. Thereby, it is possible to reduce the noise that is to be generated when vibrating the operation unit 11′ and to stably vibrate the operation unit 11′.

In the operation unit 11′ shown in FIGS. 13A and 13B, each of the second regions 11c′, 11d′ has a shape extending in a propagation direction of the wave for vibrating the operation unit 11′. For example, each of the second regions 11c′, 11d′ has a substantially rectangular shape extending in the propagation direction of the wave for vibrating the first region 11b′, i.e., in the X-axis direction.

In this case, the second regions 11c′, 11d′ can prevent the propagation of the wave for vibrating the operation unit 11′ from being blocked. Thereby, it is possible to further stabilize the vibration of the operation unit 11′.

In the meantime, each size of the second regions 11c′, 11d′ is not particularly limited inasmuch as it can provide a vibration plate 11e′ with the rigidness so as to stably vibrate the vibration plate 11e′. For example, each length of the second regions 11c′, 11d′ in the X-axis direction may be greater or smaller than a distance between the first vibrating element 13a′ and the second vibrating element 13b′.

Each of the second regions 11c′, 11d′ is preferably one region. In this case, it is possible to more easily arrange each of the second regions 11c′, 11d′ in the operation unit 11′.

In the operation unit 11′ shown in FIGS. 13A and 13B, the second regions 11c′, 11d′ are provided at positions at which the first region 11b′ is sandwiched therebetween. For example, the second regions 11c′, 11d′ are provided to be substantially symmetrical with respect to the first region 11b′.

In this case, the second regions 11c′, 11d′ can provide the operation unit 11′ with the rigidness in a substantially symmetrical manner. Thereby, it is possible to further stabilize the vibration of the operation unit 11′.

In the operation unit 11′ shown in FIGS. 13A and 13B, the operation unit 11′ has the vibration plate 11e′ having the operation surface 11a′. The first vibrating element 13a′ and the second vibrating element 13b′ are configured to vibrate the vibration plate 11e′.

The first region 11b′ is a region on the vibration plate 11e′. The second region 11c′ is formed by bonding a first reinforcement member 101a′ to one side surface of the vibration plate 11e′. The second region 11d′ is formed by bonding a second reinforcement member 101b′ to one side surface of the vibration plate 11e′.

Each of the first reinforcement member 101a′ and the second reinforcement member 101b′ is a substantially rectangular member having long sides in the X-axis direction, for example. Each of the first reinforcement member 101a′ and the second reinforcement member 101b′ is bonded to one side surface of the vibration plate 11e′ by an adhesive or an adhesive tape, for example. In this case, the first reinforcement member 101a′ and the second reinforcement member 101b′ are bonded to one surface of the vibration plate 11e′, so that it is possible to simply form the second regions 11c′, 11d′ having the rigidness higher than the rigidness of the first region 11b′.

Each material of the first reinforcement member 101a′ and the second reinforcement member 101b′ is not particularly limited. Each material of the first reinforcement member 101a′ and the second reinforcement member 101b′ may be metal such as stainless steel, glass or ceramic, for example.

However, when the operation unit 11′ is a touch pad configured to detect a position by a change in electrostatic capacitance, for example, each material of the first reinforcement member 101a′ and the second reinforcement member 101b′ is preferably glass or ceramic, not metal that is a conductive material. In this case, it is possible to reduce influences of the first reinforcement member 101a′ and the second reinforcement member 101b′ on the operation of the operation unit 11′ configured to receive the user's touch operation on the operation surface 11a′.

As a material of the vibration plate 11e′, a transmitting material such as glass, organic glass or polycarbonate may be used, for example. However, the material of the vibration plate 11e′ is not limited to the transmitting material. For example, as the material of the vibration plate 11e′, polyvinyl chloride resin, silicon resin or silicon rubber may also be used.

[Second Configuration Example of Operation Unit 11′]

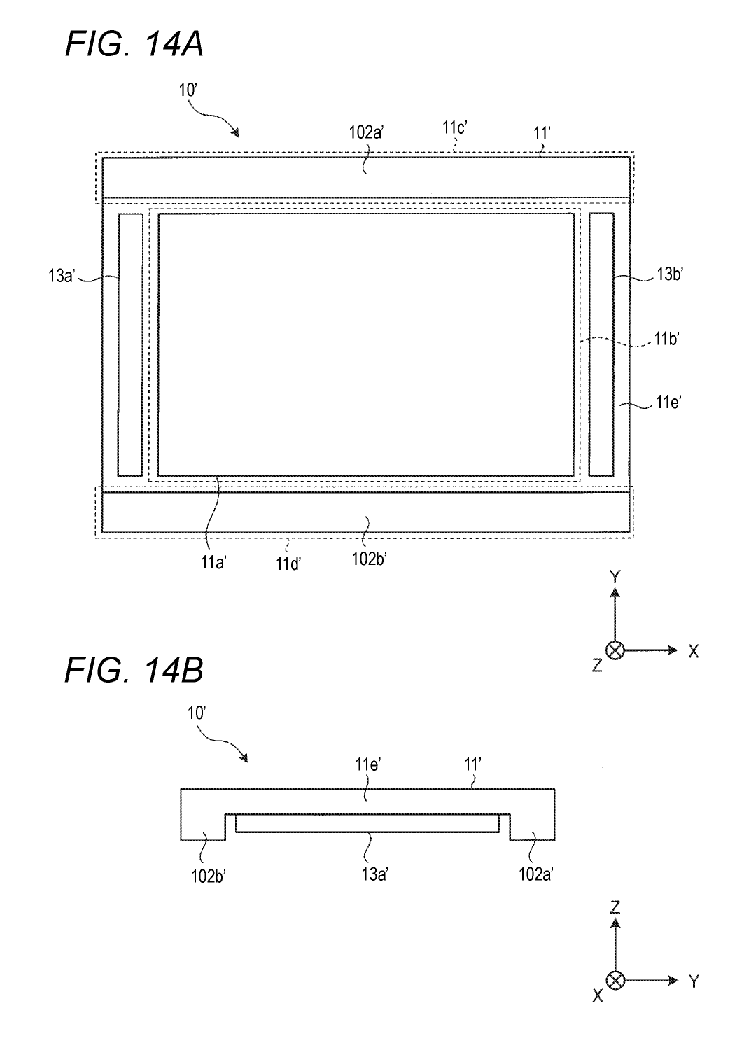

Subsequently, a second configuration example of the operation unit 11′ shown in FIG. 9 is described with reference to FIGS. 14A and 14B. FIG. 14A is a plan view illustrating the second configuration example of the operation unit 11′. FIG. 14B is a side view illustrating the second configuration example of the operation unit 11′. Also, like the example shown in FIGS. 13A and 13B, in the example of FIGS. 14A and 14B, the first vibrating element 13a′ and the second vibrating element 13b′ are also shown for convenience of descriptions.

The constitutional elements of the operation unit 11′ shown in FIGS. 14A and 14B, which are the same or similar as or to the constitutional elements of the operation unit 11′ shown in FIGS. 13A and 13B, are denoted with the same reference numerals as those of FIGS. 13A and 13B, and the descriptions thereof are omitted or simplified. The operation unit 11′ shown in FIGS. 14A and 14B is different from the operation unit 11′ shown in FIGS. 13A and 13B, with respect to the configuration of the second regions 11c′, 11d′ included in the operation unit 11′.

The operation unit 11′ shown in FIGS. 14A and 14B has the vibration plate 11e′ having the operation surface 11a′, and a thickness of the vibration plate 11e′ in each of the second regions 11c′, 11d′ is greater than a thickness of the vibration plate 11e′ in the first region 11b′. For example, the vibration plate 11e′ has a first convex part 102a′ in the second region 11c′ and a second convex part 102b′ in the second region 11d′.

In this way, the second region 11c′ is formed by the first convex part 102a′ having a thickness greater than the thickness of the vibration plate 11e′ in the first region 11b′. The second region 11d′ is formed by the second convex part 102b′ having a thickness greater than the thickness of the vibration plate 11e′ in the first region 11b′.

In this case, as the vibration plate 11e′, each of the second regions 11c′, 11d′ can be formed integrally with the first region 11b′. For example, the operation unit 11′ may be formed with the second regions 11c′, 11d′ without providing the reinforcement member on at least one surface of the vibration plate 11e′.

In order form the vibration plate 11e′ having the first convex part 102a′ and the second convex part 102b′, a flat plate for forming the vibration plate 11e′ may be processed by grinding, polishing, mechanical etching or chemical etching means. For example, a flat plate for forming the vibration plate 11e′ may be processed so as to reduce a thickness of a part excepts for parts corresponding to the first convex part 102a′ and the second convex part 102b′, for example, a thickness of a central part.

Meanwhile, in the second configuration example of the operation unit 11′, as a material of the vibration plate 11e′, the material of the vibration plate 11e′ in the first configuration example of the operation unit 11′ may be used.

[Third Configuration Example of Operation Unit 11′]

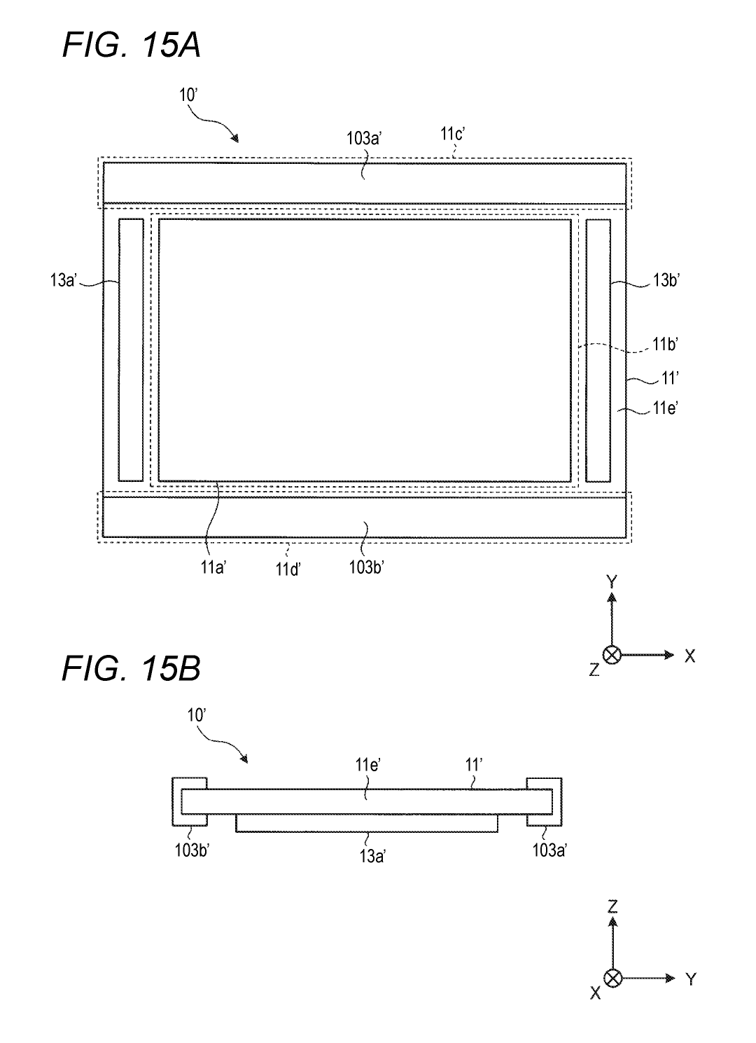

Subsequently, a third configuration example of the operation unit 11′ shown in FIG. 9 is described with reference to FIGS. 15A and 15B. FIG. 15A is a plan view illustrating the third configuration example of the operation unit 11′. FIG. 15B is a side view illustrating the third configuration example of the operation unit 11′. Also, like the example shown in FIGS. 13A and 13B, in the example of FIGS. 15A and 15B, the first vibrating element 13a′ and the second vibrating element 13b′ are also shown for convenience of descriptions.

The constitutional elements of the operation unit 11′ shown in FIGS. 15A and 15B, which are the same or similar as or to the constitutional elements of the operation unit 11′ shown in FIGS. 13A and 13B, are denoted with the same reference numerals as those of FIGS. 13A and 13B, and the descriptions thereof are omitted or simplified. The operation unit 11′ shown in FIGS. 15A and 15B is different from the operation unit 11′ shown in FIGS. 13A and 13B, with respect to the configuration of the second regions 11c′, 11d′ included in the operation unit 11′.

The operation unit 11′ shown in FIGS. 15A and 15B has the vibration plate 11e′ having the operation surface 11a′, and the second region 11c′ is formed by fitting a first reinforcement member 103a′ to upper, side and lower surfaces of the vibration plate 11e′. The second region 11d′ is formed by fitting a second reinforcement member 103b′ to upper, side and lower surfaces of the vibration plate 11e′.

Each of the first reinforcement member 103a′ and the second reinforcement member 103b′ is a member having a substantially U-shaped section in a YZ plane, as shown in FIG. 15B. Each of the first reinforcement member 103a′ and the second reinforcement member 103b′ is fitted to the upper, side and lower surfaces of the vibration plate 11e′ by inserting a peripheral part of the vibration plate 11e′ into a concave portion of the member having a substantially U-shaped section.

Meanwhile, in the third configuration example of the operation unit 11′, as materials of the vibration plate 11e′, the first reinforcement member 103a′ and the second reinforcement member 103b′, the materials of the vibration plate 11e′, the first reinforcement member 103a′ and the second reinforcement member 103b′ in the first configuration example of the operation unit 11′ can be used.

In this case, it is possible to more easily form the second regions 11c′, 11d′ having the rigidness higher than the rigidness of the first region 11b′ by fitting the first reinforcement member 103a′ and the second reinforcement member 103b′ to the upper, side and lower surfaces of the vibration plate 11e′.

In the meantime, each configuration of the second regions 11c′, 11d′ of the operation unit 11′ is not limited to the above-described configuration. For example, each of the second regions 11c′, 11d′ may be formed by providing a concave portion in a surface of the vibration plate 11e′ and embedding a reinforcement member in the concave portion provided in the surface of the vibration plate 11e′. In this case, it is possible to more easily position the reinforcement member by the concave portion provided in the surface of the vibration plate 11e′.

The additional effects and modified embodiments can be easily deduced by one skilled in the art. For this reason, the wider aspect of the disclosure is not limited to the above-described specific and representative illustrative embodiments. Therefore, a variety of changes can be made without departing from the spirit or scope of concepts of the general inventions defined by the claims and equivalents thereto.

What is claimed is:

1. An input device configured to receive a user's touch operation and to output a control signal, the input device comprising:
a first plate configured to receive the user's touch operation;
a vibrator configured to vibrate the first plate; and
a second plate fixed with a predetermined interval between the first plate and the second plate and configured to support the first plate.

2. The input device according to claim 1,
wherein the vibrator is provided at an end portion of the first plate, and
wherein the second plate and the first plate are partially bonded to each other in the vicinity of the end portion.

3. The input device according to claim 1, wherein the vibrator is arranged at a position at which an amplitude of a stationary wave is greatest when the stationary wave is generated in the first plate by the vibrator.

4. The input device according to claim 1, wherein a planar shape of each of the first plate and the vibrator is a rectangular shape and the vibrator is arranged so that long sides of the vibrator follow short sides of the first plate.

5. The input device according to claim 1, further comprising:
a touch panel configured to detect the user's touch position; and
a control unit configured to change vibration, which is to be caused by the vibrator, in correspondence to the touch position.

6. A system comprising:
the input device according to claim 5; and
a function unit configured to implement a function corresponding to the touch position detected at the touch panel.

7. A method of manufacturing an input device, the method comprising:
arranging a vibrator at an end portion of a first plate configured to receive a user's touch operation, the vibrator being configured to vibrate the first plate with a frequency higher than a human audible range; and
partially bonding the first plate and a second plate configured to support the first plate with a predetermined interval in the vicinity of an end portion.

8. An input device comprising:
an operation unit having an operation surface;
a detecting unit configured to detect a user's touch operation on the operation surface;
a vibrating element configured to vibrate the operation unit; and
a vibration control unit configured to control the vibration of the vibrating element on the basis of the touch operation detected by the detecting unit,
wherein the operation unit has a first region having the operation surface and a second region provided at a periphery of the first region and having rigidness higher than rigidness of the first region.

9. The input device according to claim 8, wherein the second region has a shape extending in a propagation direction of a wave for vibrating the operation unit.

10. The input device according to claim 8, wherein the second region is provided at a position at which the first region is sandwiched therebetween.

11. The input device according to claim 8,
wherein the operation unit comprises a vibration plate having the operation surface, and
wherein the second region is formed by providing a reinforcement member on at least one surface of the vibration plate.

12. The input device according to claim 11, wherein a material of the reinforcement member is stainless steel, glass or ceramic.

13. The input device according to claim 8,
wherein the operation unit comprises a vibration plate having the operation surface, and
wherein a thickness of the vibration plate in the second region is greater than a thickness of the vibration plate in the first region.

14. A display device comprising:
the input device according to claim 8; and
a display unit configured to display information on the basis of a touch operation detected by the detecting unit included in the input device.
